(19) United States
(12) Patent Application Publication
(10) Pub. No.: US 2023/0041302 A1
(43) Pub. Date: Feb. 9, 2023

(54) THRESHING CONCAVE FOR USE IN A COMBINE HARVESTER

(71) Applicant: AGCO International GmbH, Neuhausen (CH)

(72) Inventor: Dennis NOHRDEN, Marktoberdorf (DE)

(21) Appl. No.: 17/444,298

(22) Filed: Aug. 3, 2021

(51) Int. Cl. A01F 12/26; A01F 7/06; A01F 12/18

(52) U.S. Cl. CPC A01F 12/26; A01F 7/06; A01F 12/185; A01D 41/06

(57) ABSTRACT

A threshing concave has two curved end plates spaced from one another and a set of concave bars extending between the end plates. An elongate gap is presented between each adjacent pair of the concave bars, through which gaps threshed grain can pass during operation. Concave rods extend in the same direction as the end plates and through holes provided in the concave bars. One or more blanking plates are releasably bolted to the end plates and extend along respective elongate gaps.

### FIELD OF INVENTION

The invention relates to threshing concaves for use in combine harvester threshing systems, the concaves having two curved end plates spaced from one another and a plurality of concave bars extending between the end plates and being positioned to present an elongate gap between adjacent pairs of the concave bars for passage of threshed grain.

### BACKGROUND

For many decades combine harvesters have been used by farmers to harvest a wide range of crops including cereals, corn, beans and canola. Typically a combine harvester cuts the crop material, threshes the grain therefrom, separates the grain from the straw and cleans the grain before storing in an on-board tank. Straw and crop residue is ejected from the rear of the machine.

Different threshing systems are known. Some threshing systems operate on a tangential-flow principal wherein crop material is conveyed tangentially between a rotating threshing cylinder and a curved foraminous grate, commonly known as a ‘concave’. The crop material is threshed by a close rubbing action that occurs between the threshing cylinder and the concave. A proportion of the grain and chaff that is threshed from the bulk of the crop material falls through the concave and into a downstream cleaning system. Other threshing systems operate on an axial-flow principal wherein the crop material is conveyed as a ribbon in a spiral path between a threshing/separating rotor and a concave. In both systems, the spacing between the concave and the threshing cylinder/rotor is typically adjustable to cater for different crops and harvest conditions.

For those threshing systems that operate on the axial flow principal it is known to provide a set of interchangeable concave segments of different designs to cater for different harvest conditions. For example, less aggressive concaves may be utilised for harvesting corn to reduce grain damage. The concaves may also be configurable to adjust the open area through which grain can fall so as to change the longitudinal or transverse distribution of material falling onto to the underlying cleaning system. However, the use of multiple concave sets is costly and cumbersome with the need to transport and/or store the redundant concaves when not in use. Moreover, the concaves are heavy and the act of interchanging between the different sets typically requires significant downtime.

### SUMMARY OF THE INVENTION

In accordance with an aspect of the invention there is provided a threshing concave for use in a combine harvester threshing system. The threshing concave comprises two curved end plates spaced from one another and a plurality of concave bars extending between the end plates. The concave bars are positioned to present an elongate gap between adjacent pairs for passage of threshed grain. A plurality of concave rods extend in the same direction as the end plates, and extend through holes in the concave bars. One or more blanking plates are bolted to the end plates, each blanking plate extending along the elongate gap. The provision of blanking plates that are simply bolted to the end plates allows for simple and convenient adaption of the open area of the concave to cater for different harvest conditions.

The blanking plate or plates simply slot between adjacent pairs of the concave plates so as to selectively close a portion of the concave to the passage of threshed material. By effectively reducing the open area of the concave in this manner the distribution of threshed material falling through the concave can be shifted downstream, which is typically rearwardly. As such, blanking plates can be installed to reduce loading on a grain pan located below for example.

The blanking plates are preferably provided with mounting tabs which preferably extend radially outward so as to nest against the end plates. The blanking plates may be conveniently installed from the outside of the threshing system by positioning them under the concave rods from a radially-outward side. Alternatively, the blanking plates may be positioned over the concave rods.

### BRIEF DESCRIPTION OF THE DRAWINGS

Further advantages of the invention will become apparent from the following description of specific embodiments with reference to the appended drawings in which:

FIG. 1 is a schematic side representation of a combine harvester cut away to reveal the inside workings thereof;

FIGS. 2A-F show various views of a concave in accordance with a first embodiment; and,

FIGS. 3A-E show various views of a concave in accordance with a second embodiment.

### DETAILED DESCRIPTION

The illustrations presented herein are not actual views of any combine harvester or concave, but are merely idealized representations that are employed to describe example embodiments of the present disclosure. Additionally, elements common between figures may retain the same numerical designation.

The following description provides specific details of embodiments of the present disclosure in order to provide a thorough description thereof. However, a person of ordinary skill in the art will understand that the embodiments of the disclosure may be practiced without employing many such specific details. Indeed, the embodiments of the disclosure may be practiced in conjunction with conventional techniques employed in the industry. In addition, the description provided below does not include all elements to form a complete structure or assembly. Only those process acts and structures necessary to understand the embodiments of the disclosure are described in detail below. Additional conventional acts and structures may be used. Also note, the drawings accompanying the application are for illustrative purposes only, and are thus not drawn to scale.

Relative terms such as forward, rearward, transverse, lateral, longitudinal and sideways will be made with reference to the normal forward direction of travel of the combine 10 and indicated by arrow F. The terms vertical and horizontal will be made with reference to the level ground 101 upon which the combine 10 is disposed. In other words the Cartesian axes of ‘longitudinal’, ‘transverse’, and ‘vertical’ are made in relation to the frame 12 of combine 10 and are not affected by any slope in the ground. The terms “upstream” and “downstream” are made with reference of the general direction of crop flow along the material conveyance systems described.

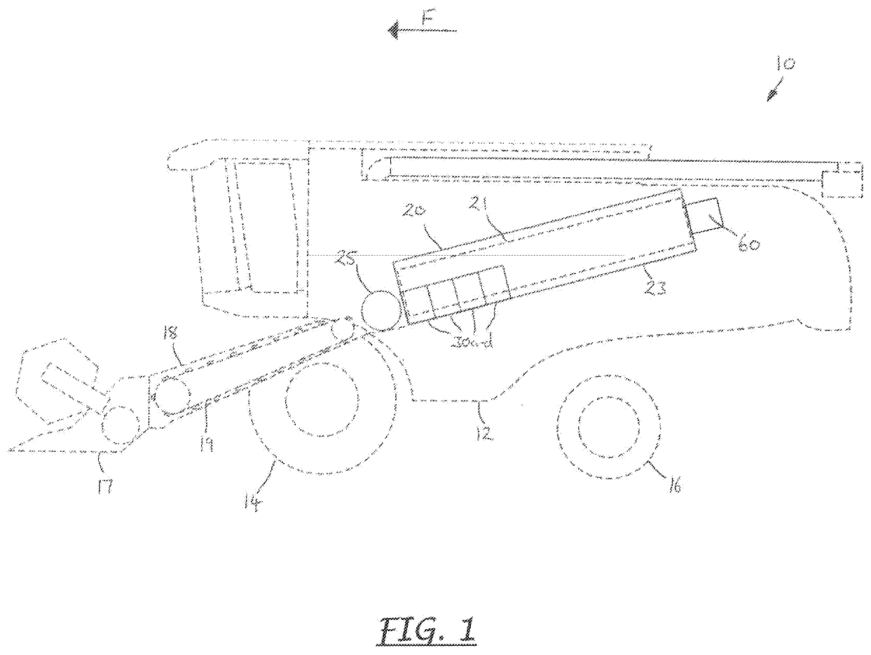

With reference to FIG. 1 a combine harvester 10 includes a frame or chassis 12, front wheels 14 and rear steerable wheels 16. A cutting header 17 is detachably supported on the front of a feederhouse 18 which is pivotable about a transverse axis to lift and lower the header 17 in a conventional manner.

The combine 10 is driven in a forward direction F across a field of standing crop in a known manner. The header 17 serves to cut and gather the crop material before conveying such into feederhouse 18 and elevator 19 housed therein. At this stage the crop stream is unprocessed. It should be understood that combine harvesters are employed to harvest a host of different crops including cereal, rice, corn and grass seed. The following description will make reference to various parts of the cereal crop stream but it should be understood that this is by way of example only and does not by any means limit the applicability of the invention to harvesting other crops.

The cut crop stream is conveyed rearwardly from the feederhouse 18 to a processor designated generally at 20. The processor 20 includes one or two axial flow threshing and separating rotors 21 which are each housed inside a respective rotor housing 23 and which are preferably fed at their front end by a feed beater 25. The rotors serve to thresh the crop stream in a front ‘threshing’ region, separate the grain therefrom in a rear ‘separating’ region, and eject the straw residue through the rear of the machine either directly onto the ground in a windrow or via a straw chopper.

Each rotor housing 23 is generally cylindrical and is made up of an opaque upper section and a foraminous lower section which includes a set of side-by-side arcuate concave grate segments, hereinafter referenced simply as ‘concaves’, which allow the separated material to fall by gravity onto a grain collection pan located below for onward conveyance to a cleaning system (not shown). Guide vanes (not shown) may be secured to the inside of the rotor housing and serve, in conjunction with the crop engaging elements on the rotor, to convey the stream of crop material in a generally rearward spiral path from front to rear.

The concaves are positioned underneath the respective rotors 21 and wrap around a portion of the cylindrical envelope swept by the rotors. The individual concaves are carried upon support structures that are movably mounted to the frame 12 so as to allow adjustment of the clearance between the concaves 30a-d and the rotors 21.

A detailed description of the concave support structures or the downstream material processing systems is not necessary for the understanding of the invention. However, a more detailed description of such is given in US-2020/221642 to which reference is invited, and the content of which is incorporated herein by reference.

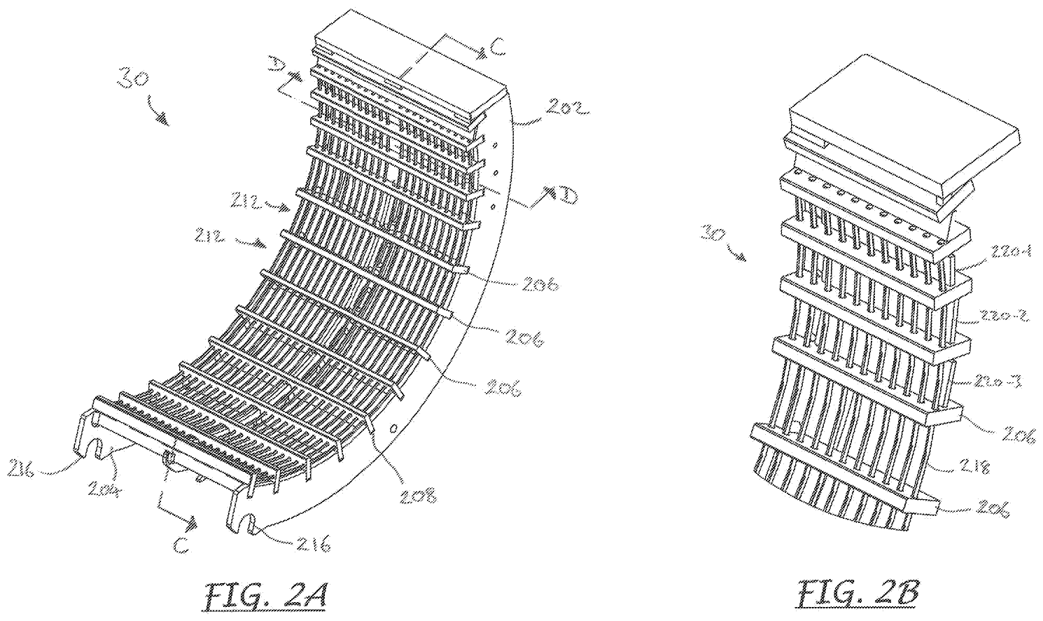

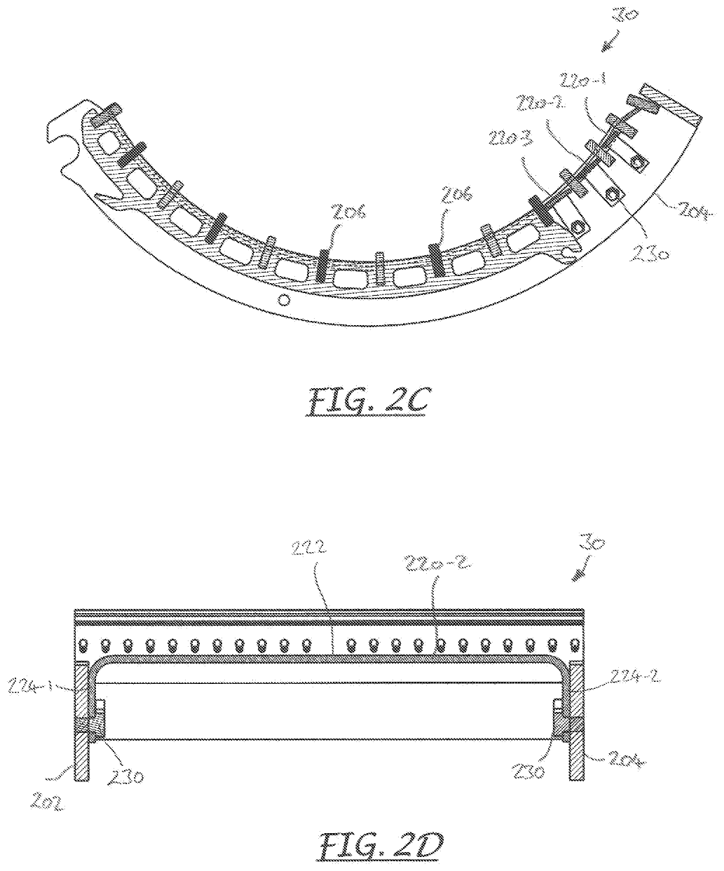

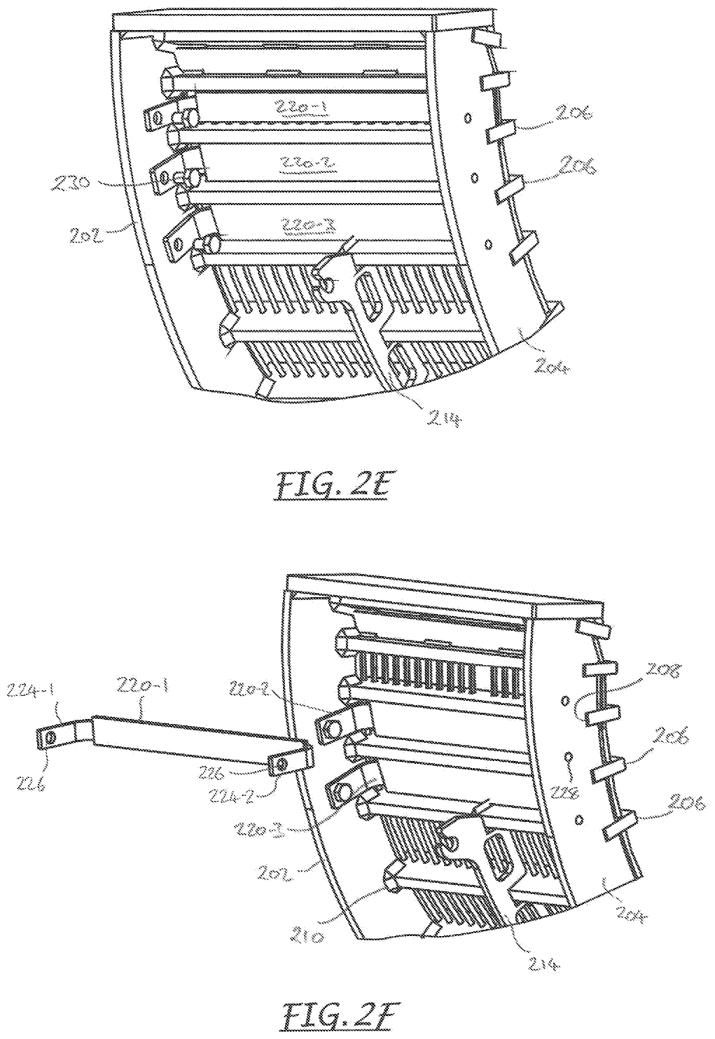

With reference to FIGS. 2A-F a single concave 30 is shown in accordance with a first embodiment. It should be understood that concave 30 may form one of a set of identical concaves as described above, the concaves being mounted in a juxtaposed relationship underneath a threshing rotor so as to interact therewith to deliver a threshing action to crop material passed therebetween. Relative terms such as ‘radial’, ‘axial’ and ‘circumferential’ used hereinafter are made with general reference to the rotation axis of the threshing rotor under which the concave is to be installed during operation.

The concave 30 comprises two end plates 202,204 which are axially spaced apart from one another. Each end plate 202, 204 is curved or arcuate in shape, extending circumferentially so as to partially extend around the swept envelope of a threshing rotor. A plurality of concave bars 206 extend in the axial direction between, and perpendicular to, the end plates 202, 204. In the illustrated embodiment fourteen concave bars 206 are shown but it should be appreciated that more or less may be provided as per design choice. The concave bars 206 are spaced apart and extend parallel to one another. The concave bars 206 preferably have a rectangular section profile (best seen in FIG. 2C) which is received by slots 208 cut into the end plates 202, 204. The concave bars 206 may be welded to the end plates 202, 204 at weld joints 210 to provide a rigid structure. Both the end plates 202, 204 and the concave bars 206 are preferably formed from steel plate or similar material.

Axially-extending elongate gaps 212 are presented between each adjacent pair of the concave bars 206 for passage of threshed grain. An aspect of the invention relates to means for selectively blanking off one or more of the gaps 212 and will be discussed in more detail below.

Best shown in FIGS. 2E and 2F, a strengthening rib 214 is provided midway between the end plates 202, 204, the rib 214 being curved and extending in the same direction as the end plates 202, 204. For completeness, each end plate 202, 204 may be provided with a notch 216 which hooks over a support bar of a concave support structure (not shown) as is known in the art.

A plurality of concave rods 218 extend parallel to the end plates 202, 204 through holes (drillings) provided in the concave bars 206. This is best shown in FIG. 2B which shows concave 30 with the end plates cut away. The concave rods 218 are axially spaced and, together with the concave bars 206, form a grid or grate with openings through which the threshed material can pass in a known manner. The concave rods 218 preferably have a round section profile.

One or more blanking plates 220 are bolted to the end plates 202, 204 to blank off, or close, a respective one of the gaps 212 presented between the concave bars 206. The illustrated embodiment comprises three blanking plates 220-1, 220-2, 220-3 each covering a respective gap and blocking the passage of grain therethrough. However, it should be appreciated that fewer or more than three blanking plates may be used.

With reference to FIG. 2F, each blanking plate 220 is preferably formed from rigid plate having a rectangular section profile. For example, each blanking plate 220 may be formed from rectangular section steel plate. When bolted in position, each blanking plate 220 extends in the axial direction with a major surface 222 facing radially inward with respect to the threshing rotor axis. Two mounting tabs 224-1, 224-2 are provided, preferably formed integrally with the blanking plate 220, and extend radially away from respective ends of the blanking plate 220. The mounting tabs 224-1, 224-2 preferably have a narrower section than the main portion. The tabs 224-1, 224-2 may be formed by simply bending end portions of the rigid plate at approximately 90 degrees to the major surface 222.

A hole 226 (drilling) is provided through each mounting tab 224 with corresponding holes 228 in the end plates 202, 204. Bolts or pins 230 are inserted through the holes 226, 228 to secure the blanking plates 220 in place during operation. A nut or other suitable device retains the bolt 230 in place.

In a first embodiment, illustrated in FIGS. 2A-F, the blanking plates 220 are each positioned under the concave rods 218 from the radially outer side, that is from the side opposite to that interacting with the threshing rotor. Advantageously, by being able to position the blanking plates 220 from the radially outer side, there is no need to remove the concaves 30 to add or remove the blanking plates 220 because access to the inside of the rotor cage 20 is not required. This saves downtime when adding or removing the blanking plates.

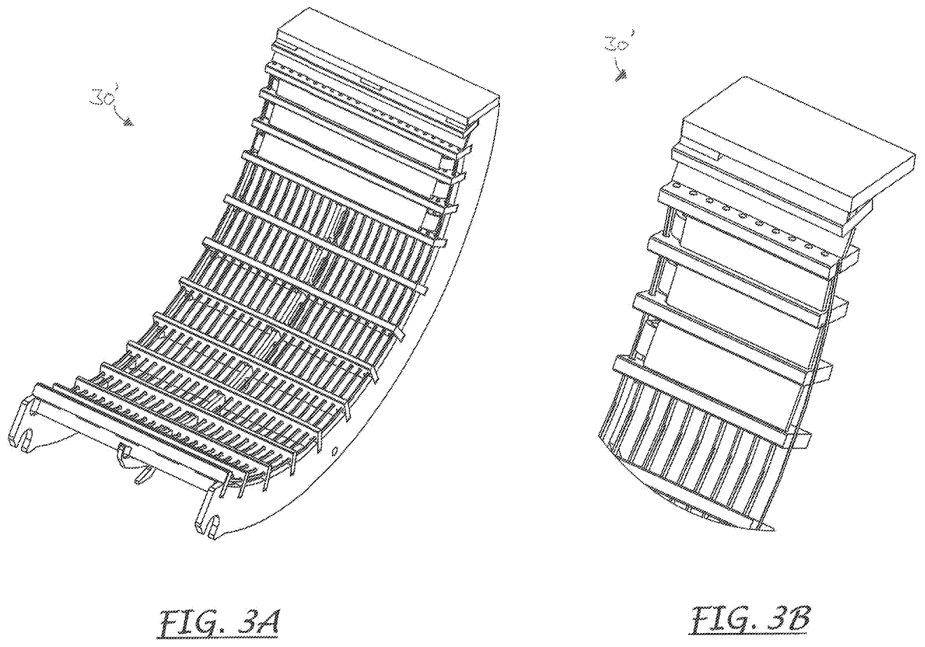

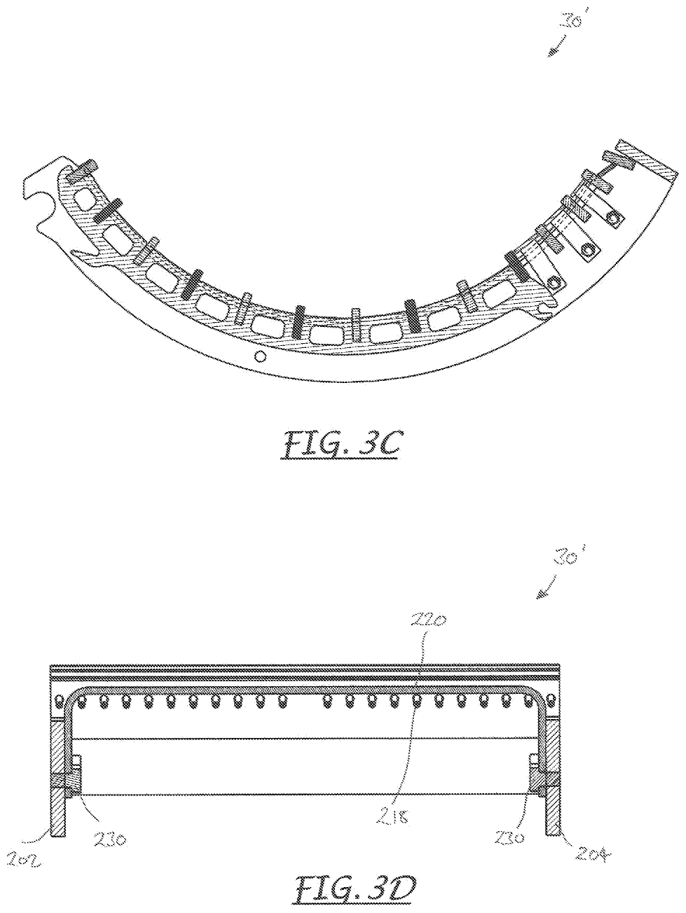

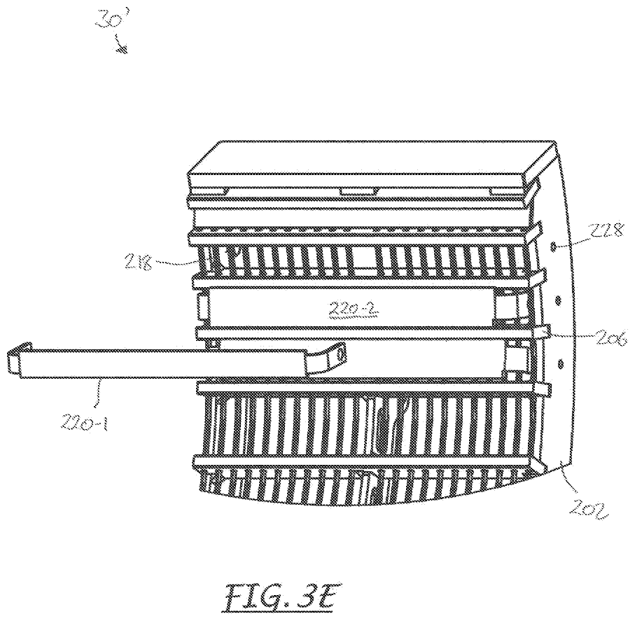

In a second embodiment, illustrated in FIGS. 3A-E, the blanking plates 220 are each positioned over the concave rods 218 from the radially inward side, that is, from the side that interacts with the threshing rotor. Removal or adding of blanking plates 220 may, as such, first require removal of the concaves 30′ to obtain suitable access.

As harvest conditions change then an operator may choose to selectively blank off one or more of the gaps 212 between adjacent pairs of the concave bars 206. Blanking plates 220 as disclosed can be conveniently bolted to the concave side plates 202, 204 or removed as required.

In summary, there is provided a threshing concave having two curved end plates spaced from one another and a set of concave bars extending between the end plates. An elongate gap is presented between each adjacent pair of the concave bars, through which gap threshed grain can pass during use. Concave rods extend in the same direction as the end plates and through holes in the concave bars. A blanking plate is releasably bolted to the end plates and extends along the elongate gap.

While the present disclosure has been described herein with respect to certain illustrated embodiments, those of ordinary skill in the art will recognize and appreciate that it is not so limited. Rather, many additions, deletions, and modifications to the illustrated embodiments may be made without departing from the scope of the disclosure as hereinafter claimed, including legal equivalents thereof. In addition, features from one embodiment may be combined with features of another embodiment while still being encompassed within the scope as contemplated by the inventor. Further, embodiments of the disclosure have utility with different and various machine types and configurations.

1. A threshing concave for use in a combine harvester threshing system, the threshing concave comprising:
two curved end plates spaced from one another;
a plurality of concave bars extending between the end plates and being positioned to present an elongate gap between adjacent pairs of the plurality of concave bars for passage of threshed grain;
a plurality of concave rods extending in the same direction as the end plates, and which extend through holes in the concave bars; and,
a blanking plate bolted to the end plates and extending along the elongate gap.

2. The threshing concave of claim 1, wherein the blanking plate is formed from rigid plate having a rectangular section profile.

3. The threshing concave of claim 1, wherein the blanking plate extends axially with respect to a curved profile of the end plate, and comprises two mounting tabs that extend radially outward.

4. The threshing concave of claim 1, wherein the blanking plate extends under the concave rods within the elongate gap from a radially-outward side.

5. The threshing concave of claim 4, wherein the blanking plate extends axially with respect to a curved profile of the end plate, and comprises two mounting tabs that extend radially outward.

6. The threshing concave of claim 4, wherein corresponding holes are provided in the respective mounting tabs and the end plates, the holes receiving bolts to fasten the blanking plate with respect to the end plates.

7. The threshing concave of claim 1, wherein the blanking plate extends over the concave rods within the elongate gap from a radially-inward side.

8. The threshing concave of claim 7, wherein the blanking plate extends axially with respect to a curved profile of the end plate, and comprises two mounting tabs that extend radially outward through gaps formed between the concave rods, wherein corresponding holes are provided in the respective mounting tabs and the end plates, the holes receiving bolts to fasten the blanking plate with respect to the end plates.

9. A threshing system, having a threshing cylinder or rotor and the threshing concave of claim 1 interacting therewith.

10. A combine harvester comprising the threshing system of claim 9.
